(19) United States
(12) Patent Application Publication
(10) Pub. No.: US 2020/0232575 A1
(43) Pub. Date: Jul. 23, 2020

(54) VALVE

(71) Applicants: Carroll Dearman, Owasso, OK (US); Gary Williams, Broken Arrow, OK (US)

(72) Inventors: Carroll Dearman, Owasso, OK (US); Gary Williams, Broken Arrow, OK (US)

(73) Assignee: Baker Hughes, a GE company, LLC, Houston, TX (US)

(21) Appl. No.: 16/254,153

(22) Filed: Jan. 22, 2019

(51) Int. Cl. F16K 31/06; F16K 5/06

(52) U.S. Cl. CPC F16K 31/062; F16K 31/0675; F16K 5/0657; F16K 5/0652

(57) ABSTRACT

A valve including a housing having a coil therein; a seat in the housing; a ball disposed against the seat, the ball rotationally responsive to a magnetic field generated in the coil.

### BACKGROUND

In the resource recovery industry valves are often used to control fluid flow for a plethora of reasons. This includes in some cases to prevent fluid flow under conditions that might otherwise be undesirable. Some such valves are configured to close in the absence of an impetus to stay open. These are vernacularly known as safety valves. There are many types of valves and many configurations for the same but there is also an insatiable desire in the industry for alternative configurations that improve efficiency, reduce cost, reduce complexity, etc.

### SUMMARY

A valve including a housing having a coil therein; a seat in the housing; a ball disposed against the seat, the ball rotationally responsive to a magnetic field generated in the coil.

### BRIEF DESCRIPTION OF THE DRAWINGS

The following descriptions should not be considered limiting in any way. With reference to the accompanying drawings, like elements are numbered alike:

FIG. 1 is a schematic illustration of a valve as disclosed herein in a closed position;

FIG. 2 is the valve of FIG. 1 in an open position;

FIG. 3 is an illustration of a ball of the valve of FIG. 1; and

FIG. 4 is a schematic view of a wellbore system employing the valve as disclosed herein.

### DETAILED DESCRIPTION

A detailed description of one or more embodiments of the disclosed apparatus and method are presented herein by way of exemplification and not limitation with reference to the Figures.

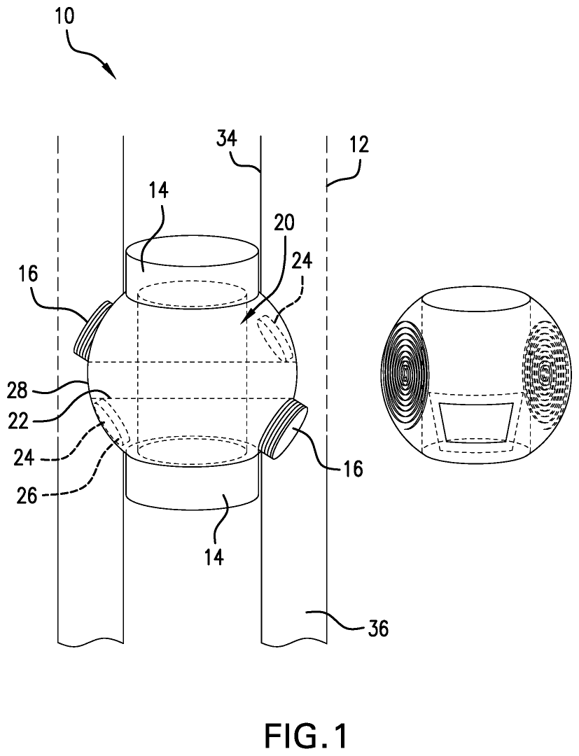

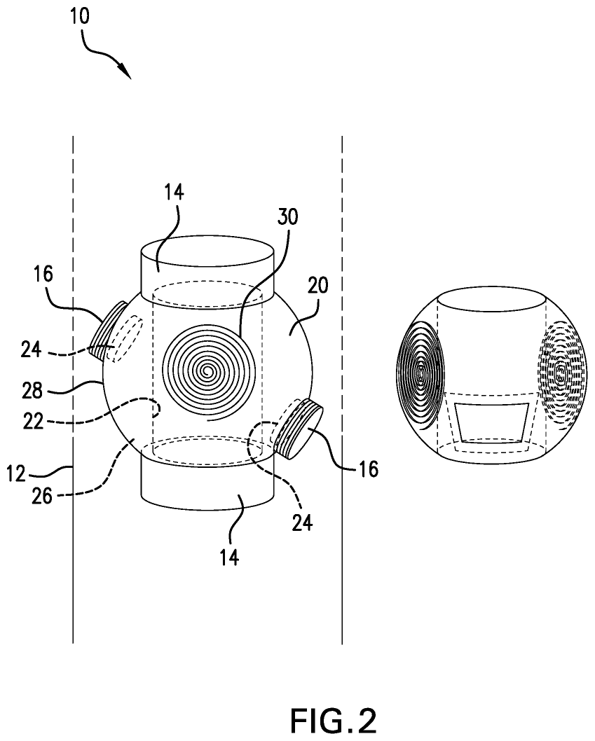

Referring to FIGS. 1 and 2, a valve 10 is illustrated in a closed position and an open position respectively. The valve 10 comprises a housing 12 having a seat assembly 14 (in some embodiments, a pair of seat assemblies may be used as illustrated). Also disposed in the housing is a coil 16. In some embodiments more than one coil may be employed. Two are illustrated but this is not intended to be limiting. Rather as many coils as may be practical is contemplated. It is noted that more coils may reduce the size needed for each coil. The coil 16 functions as an electromagnet and is supplied electric energy from a power source that may be located at a remote location such as the surface or may be supplied more locally in the form of a battery or generator, for example. In any event, the power source will be a switched source so that the “switch”, regardless of its location is capable of initiating or terminating the flow of electric energy to the coil 16 and hence to generate a magnetic field with the coil 16. The importance of this will become clear in the discussion on operation. Of course, any damage to the power supply or a communication conduit requiring the valve 10 be held open will result in the closure of the valve 10.

Within the housing 12 and adjacent seat 14 (or between two seats 14) is a ball 20. The ball itself is a conventional feature of a ball valve including a generally spherical form and having a bore 22 through a center thereof. When the bore 22 is misaligned with the seat 14, no flow through the ball 20 is possible. Conversely, when the bore 22 is at least partially aligned with the seat 14 (the opening that is the bore 22 at least partially overlaps an opening of the seat 14) then flow is possible through the valve 10. The ball 20 in an embodiment also comprises a permanent magnet 24. The magnet 24 may be a part of the material of ball 20 (selectively magnetized section of the ball 20) or a separate magnet 24 embedded in the ball 20 (or disposed in a recess in the ball 20). In an embodiment where the magnet 24 is separate, an adhesive material or fastener may be used to secure the magnet 24 in the ball 20. The magnet may also be configured to have a semispherical outer face 26 that substantially matches the spherical surface 28 of the ball 20.

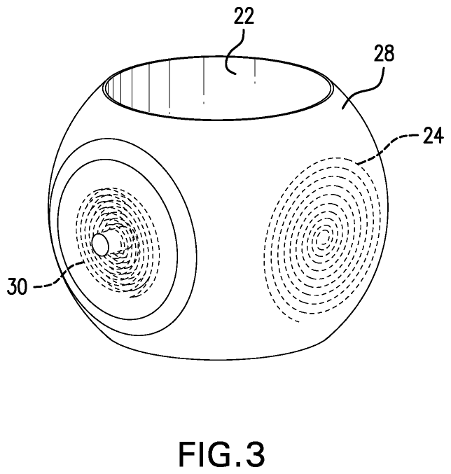

In some embodiments, the valve 10 is also possessed of an automatic valve closure arrangement 30. The arrangement 30 may comprise a resilient member 30 (or more than one) configured to become more loaded when the valve 10 is opened and less loaded when valve 10 is closed. As such, the resilient member will tend to close the valve 10 in the absence of inputs intended to open the valve 10, i.e. the actuation of the electromagnetic field in coil 16). The field, then must be sufficient to overcome the impetus of the resilient member to succeed in opening the valve. In such an embodiment, any interruption in a control signal used to cause the valve to open or in the power supplied to the valve to open will automatically result in the closure of the valve 10, in an embodiment, the resilient member is a torsion spring. FIG. 3 provides illustration of the torsion spring 30 operably connected to the ball 20 but illustrated without the housing 12 and seat 14 of the valve 10 for clarity of visualization.

In another embodiment, the automatic closure arrangement 30 may be a second permanent magnet at the same position or a near position to the coil 16 but having opposing polarity to the magnet 24, In this embodiment, the coil magnetic field must overcome the repulsive forces of the two permanent magnets working to close the valve so that the valve may be opened while power is supplied to the coil 16. If the power or control signal is lost or intentionally shut off, the coil magnetic field will dissipate and the permanent magnets with the reversed polarities will cause the valve 10 to close. It is also contemplated that the valve 10 may include both a torsion spring and an opposed polarity permanent magnet in embodiments.

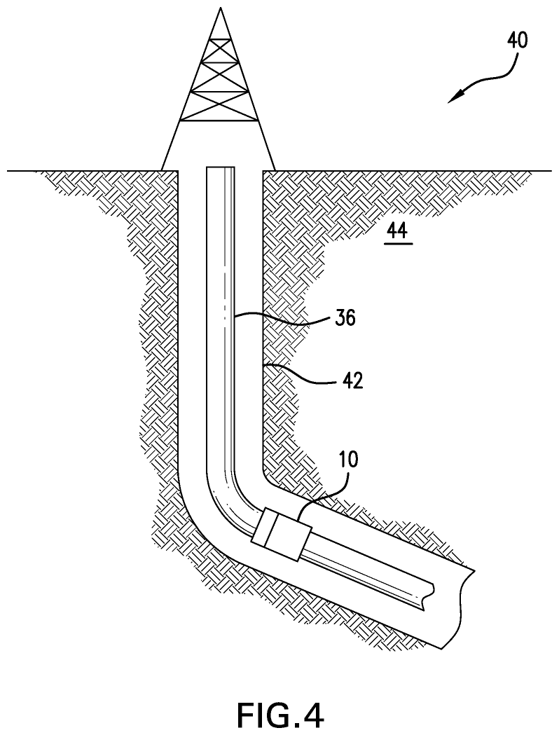

Referring back to FIGS. 1 and 2, the valve 10 is first illustrated in a closed position whereby no fluid may pass the valve 10. Upon a signal to open the valve, electric energy is supplied to the valve 10 from a power source as described above thereby energizing the coil 16 to create a magnetic field. The field will remain as long as the electric energy is provided to the coil 16. Because of the magnetic field generated, the magnet 24 is strongly attracted to the coil and the ball 20 will rotate until the magnet 24 and the coil 16 are aligned. This is illustrated in FIG. 2 with two coils and two magnets (any number of magnets or coils that may be practically positioned in relation to the ball 20 are contemplated). It will be appreciated that when the magnet 24 and coil 16 are aligned, the bore 22 is also aligned with a through passage 34 in the housing 12 so that fluid flowing into housing 12 from one direction may continue to flow out of the housing 12 in the opposite direction. Generally, the direction is from further downhole to uphole when the valve 10 is employed in a tubing string 36 of wellbore production system 40 (see FIG. 4) in a borehole 42 in a subsurface formation 44. In some embodiments the valve 10 is a subsurface safety valve and may be surface controlled.

It is noted that while embodiments having permanent magnet 24 are illustrated, some embodiments do not require a permanent magnet in or of the ball 20 but rather rely upon the different magnetic permeability of the solid material of the ball 20 about the bore 22 versus the fact that the bore 22 defines an edge of a space and that space does not respond to magnetic influence. Thereby, a torque may be placed upon the ball 20 to rotate the same with sufficient magnetic field strength from the coil 16.

Set forth below are some embodiments of the foregoing disclosure:

### Embodiment 1

A valve including a housing having a coil therein; a seat in the housing; a ball disposed against the seat, the ball rotationally responsive to a magnetic field generated in the coil.

### Embodiment 2

The valve as in any prior embodiment further including a first permanent magnet disposed at the ball.

### Embodiment 3

The valve as in any prior embodiment wherein the magnet is an integral part of the ball.

### Embodiment 4

The valve as in any prior embodiment wherein the magnet is separate from the ball.

### Embodiment 5

The valve as in any prior embodiment wherein the magnet is attached in a recess of the ball.

### Embodiment 6

The valve as in any prior embodiment further comprising an automatic closure arrangement.

### Embodiment 7

The valve as in any prior embodiment wherein the automatic closure arrangement is a resilient member.

### Embodiment 8

The valve as in any prior embodiment wherein the resilient member is a torsion spring.

### Embodiment 9

The valve as in any prior embodiment further comprising a second permanent magnet magnetically opposing the first permanent magnet.

### Embodiment 10

The valve as in any prior embodiment further including a first permanent magnet disposed at the ball and wherein the automatic closure arrangement includes both a resilient member and a second permanent magnet urging the ball to a closed position.

### Embodiment 11

A wellbore production system including a tubing string disposed in a borehole of a subsurface formation; and a valve as in any prior embodiment disposed in the tubing string.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A valve comprising:
a housing having a coil therein;
a seat in the housing;
a ball disposed against the seat, the ball rotationally responsive to a magnetic field generated in the coil.

2. The valve as claimed in claim 1 further including a first permanent magnet disposed at the ball.

3. The valve as claimed in claim 2 wherein the magnet is an integral part of the ball.

4. The valve as claimed in claim 2 wherein the magnet is separate from the ball.

5. The valve as claimed in claim 4 wherein the magnet is attached in a recess of the ball.

6. The valve as claimed in claim 1 further comprising an automatic closure arrangement.

7. The valve as claimed in claim 6 wherein the automatic closure arrangement is a resilient member.

8. The valve as claimed in claim 7 wherein the resilient member is a torsion spring.

9. The valve as claimed in claim 2 further comprising a second permanent magnet magnetically opposing the first permanent magnet.

10. The valve as claimed in claim 6 further including a first permanent magnet disposed at the ball and wherein the automatic closure arrangement includes both a resilient member and a second permanent magnet urging the ball to a closed position.

11. A wellbore production system comprising:
a tubing string disposed in a borehole of a subsurface formation; and
a valve as claimed in claim 1 disposed in the tubing string.
